(19) United States
(12) Patent Application Publication
(10) Pub. No.: US 2026/0032229 A1
(43) Pub. Date: Jan. 29, 2026

(54) APPLICATION-SPECIFIC ASSESSMENT OF IMAGING SENSORS, OF VIRTUAL IMAGING SENSORS, AND/OR THEIR SPECIFICATION

(71) Applicant: Robert Bosch GmbH, Stuttgart (DE)

(72) Inventors: Falko Matern, Erlangen (DE); Marzena Franek, Stuttgart (DE); Ulrich Seger, Leonberg-Warmbronn (DE)

(21) Appl. No.: 19/276,234

(22) Filed: Jul. 22, 2025

(30) Foreign Application Priority Data
Jul. 29, 2024 (DE) 10 2024 207 114.5

(51) Int. Cl. H04N 17/00

(52) U.S. Cl. CPC H04N 17/002

(57) ABSTRACT

A computer-implemented method for assessing an imaging sensor, an associated virtual imaging sensor and/or a specification of the imaging sensor. The specification includes at least two parameter ranges, wherein a particular parameter range is an operating range in which the imaging sensor is intended to function or an interference range with which the imaging sensor is intended to cope. The method includes receiving, for each one of one or more first tests based in each case on one of the at least two parameter ranges, a first measurement response ascertained in response to a first stimulus and/or a first response expected for the first stimulus.

### BACKGROUND INFORMATION

The assessment of the image quality of imaging sensors, the calibration and the testing or validation of sensor properties can be accomplished by evaluating “test targets” or corresponding laboratory setups. A common example is the evaluation of the color fidelity of a camera via so-called color checkers, which are recorded in various, partly standardized, lighting scenarios by a DUT (device under test). In this way, individual defined points in the color space can be verified. Such test targets come in many different forms, with the aim of measuring and assessing certain properties in the image.

Special targets, for example according to ISO standards, represent patterns and test points defined in various ISO standards. The ISO standards describe the test targets and algorithms for evaluation and exist for various properties such as resolution, noise and/or color.

Typically, the “standard-compliant” analyses are limited to exemplary static scenarios that characterize the behavior of a sensor or a sensor system at specific points, assuming that the behavior between the measured points can usually be approximated linearly. Since sensors and/or sensor systems, in particular in the automotive field, are used in natural environments and are exposed to signal variance that can exhibit high temporal dynamics but can also be adjusted to the situation through controlled or feedback parameter settings, a purely static quality metric does not suffice.

The IEEE P2020 Automotive Standard Working Group is concerned with the definition and measurement methods for describing new quality metrics for automotive sensors. In particular, an attempt is made to take into account the interaction between data quality of the sensor data, environmental conditions and perception.

In addition to test targets that allow “standard-compliant” measurements, test equipment can also be used to measure dynamic sensor properties. New test methods are being used in an attempt to close the gap between static characterization and dynamic characterization. The “dynamic test stand,” for example, makes possible the assessment of a camera's contrast separation over a certain range of light intensities (also called the dynamic range).

Virtual sensor models for simulation can also be validated and compared with reality. For this purpose, e.g. a digital twin of the above-described test facilities is used to generate the virtual sensor response to the virtual excitation in a simulation. With the aid of a comparison of the simulated result with recordings from the real sensor in response to the test excitation, the quality of the models can be measured.

The description and measurement of the performance and image quality of imaging sensors serves to develop, calibrate, benchmark, compare and select systems suitable for specific applications, as well as to estimate performance and reliability in an intended application. The common procedure for assessing a sensor component works in a static parameter field, which is realized by fixed or statically defined measurement setups. The quality of optically capturing sensors (e.g. cameras) can be ascertained, for example, by one or more of the following primary characteristics, also known as distinguishing characteristics:
Spatial resolution in separable contrasting structures such as lines [1 p/mm];
Spectral resolution in the number of available spectral channels and differentiability in the color space (e.g. ΔE in the RGB color space);
Temporal resolution in frames per second;
Separation capability of modulated excitation; and/or
Distinguishability of polarization of the incoming radiation.

Further quality characteristics (here: secondary characteristics) can be the availability of the primary characteristics via the application-specific parameter spaces, e. g.:
Dynamics of terrestrial intensities from 1 pW/m² to 1 GW/m²;
Extension of the spectrally detectable electromagnetic spectrum contributing to object distinguishability; and/or
Relative movement between object and recording system.

A further quality characteristic can be the robustness against interference variables, interference artifacts, and foreign influences affecting image quality (collectively: interference influences), some of which are unavoidable in the application, such as:
Varying properties of the signal sources (photon noise, modulated light sources);
Temperature;
Mechanical relative movement of optical elements, e.g. through feedback from the application;
Interference radiation, reflections; and/or
Effects occurring due to aging that influence primary and/or secondary properties.

Not every sensor covers all distinguishing characteristics, allows the coverage of the entire physically possible parameter space and/or is insensitive to potential interference influences.

In addition, complex bionic sensor systems in use today have the ability to locally and adaptively adjust variables such as gain, resolution, signal weighting, etc. to the detection situation. Here, the classic assessment of a sensor component in a static parameter field no longer does justice to the complex application. Today, a sensor must be regarded, in an application-specific manner, as a system consisting of a signal receiver, optionally an active excitation source, and sensor signal processing (and in some cases feedback control), and must be assessed as to its ability to separate relevant, distinguishable objects in the image.

In particular, in AI applications where a clear assignment of physical properties to characteristic-forming manifestations cannot always be unambiguously established, the ability to distinguish must be evaluated across the entire expected parameter space.

The present invention addresses the problem of being able to assess, in an application-specific manner (e.g., specific to the application case), and ultimately release real and/or virtual sensors and their specifications.

### SUMMARY

A first general aspect of the present invention relates to a method for assessing an imaging sensor, an associated virtual imaging sensor, and/or a specification of the imaging sensor. The specification comprises at least two parameter ranges, wherein a particular parameter range is an operating range in which the imaging sensor is intended to function or an interference range with which the imaging sensor is intended to cope. According to an example embodiment of the present invention, the method comprises receiving, for each of one or more first tests based in each case on one of the at least two parameter ranges, a first measurement response ascertained in response to a first stimulus and/or a first response expected for the first stimulus; and/or, for each of one or more second tests based in each case on a combination of the at least two parameter ranges, wherein one or more tuples of parameter values are formed from at least the at least two parameter ranges, a second measurement response ascertained in response to a second stimulus and/or a second response expected for the second stimulus. The method further comprises checking whether there is at least one further tuple of parameter values from the at least two parameter ranges for which a third test can be defined, the third measurement response of which ascertained in response to a third stimulus and/or the third response of which expected for the third stimulus deviating sufficiently from an interpolation of first and/or second measurement responses and/or from an interpolation of first and/or second expected responses, wherein a third test result is obtained.

A second general aspect of the present invention relates to a computer system that is configured to execute the method for assessing an imaging sensor, an associated virtual imaging sensor and/or a specification of the imaging sensor according to the first general aspect (or an embodiment thereof).

A third general aspect of the present invention relates to a computer program that is configured to execute the method for assessing an imaging sensor, an associated virtual imaging sensor and/or a specification of the imaging sensor according to the first general aspect (or an embodiment thereof).

A fourth general aspect of the present invention relates to a computer-readable medium or signal that stores and/or contains the computer program according to the third general aspect (or an embodiment thereof).

The method according to the first aspect (or an embodiment thereof) of the present invention is directed to the assessment of an imaging sensor, a virtual imaging sensor and/or a specification of the imaging sensor. The virtual imaging sensor can, for example, be a digital twin of the imaging sensor.

The method of the present invention can be used in particular for the validation and/or release of sensors or associated virtual imaging sensors.

Validation and/or release of an imaging sensor is particularly important for artificial intelligence (AI) applications. For example, an AI application can be directed to a perception task of an environment of the imaging sensor.

Validation and/or release of a virtual imaging sensor can be a prerequisite for considering the virtual imaging sensor as an alternative or additional option in the development of an imaging sensor.

In the method according to the present invention, the following aspects can be included in the generation of tests:
A) the operating range (also: application area), which can influence a detection event, e.g., within the meaning of SOTIF ISO/PAS 21448 (e.g., the occurrence of weather phenomena leading to the degradation of perceivable object characteristics)
B) the functional principle and any interference mechanisms that may affect this functional principle (e.g., pulsed signal generation at traffic lights, which generate such short signal pulses that the sampling conditions of a clocked sampling sensor are violated)
C) the variance in appearance of the object properties to be detected or distinguished, adjusted to the detection task (e.g., angle-dependent and structured reflective paint surfaces that trigger a camouflage effect in terms of spectrum and intensity), and
D) the functional adjustment flexibility inherent in the sensor (e.g., locally adaptive function control or long-term adaptive drift-compensating functions).

In order to test the properties and effects of sensors simulatively, simulation models for hardware components, i.e., virtual imaging sensors, are required. Sensor simulation is gaining increasing relevance as a tool not only for the development of components, but also for the development of perception algorithms, and is increasingly also being recognized as a release-relevant method. A digital twin of a hardware component can potentially be used in the future to reproducibly test development decisions, settings and/or their impact on subsequent components and algorithms.

However, the quality of the simulation models is crucial for generating statements with high validity by simulation methods. For example, the following questions must be answered:
How reliable is the simulation? (reproducible, comprehensible?)
Which parameter range does the simulation reliably cover? (for which operational design domain (ODD) is the simulation model valid?)
What evidence of correctness is available?

For this reason, “validated” sensor models are often required or offered by corresponding companies. However, due to the lack of standardized verification methods, it is unclear how well a sensor model, i.e. how well a virtual imaging sensor, will have been validated with respect to the relationships described above. The described method offers the possibility of classifying and assessing the scope of a validation of a virtual imaging sensor and subsequently of deducing its applicability.

The method according to the present invention for assessing an imaging sensor, an associated virtual imaging sensor and/or the specification of the imaging sensor (or embodiments thereof) can also be a method for qualifying and/or iteratively improving methods for testing sensor systems and for sensor validation. It builds on common methods and offers the opportunity to review and expand them. The method also makes it possible for buyers, customers and/or suppliers of virtual imaging sensors to assess the applicability of these virtual sensors in simulation environments.

In the validation/testing of sensor systems and in corresponding standards, the specific application case, the specific sensor technology, and specific corner cases and interference influences have so far not been adequately taken into account.

The described method of the present invention builds the validation on precisely such (application-)specific properties and additionally defines special test domains via parameter spaces, which make possible the derivation of coverage measures and thus an assessment and/or improvement of the sensor validation. In addition, the specific properties of specific sensors or sensor systems and their specific application areas are taken into account in the quality assessment.

So far, sensors have been compared using established/standardized test points. These test points are generated, e.g., by color and/or reflectance targets or even more extensive measurement setups.
Here, the same test points are used regardless of the specific sensor properties and the specific application. However, it remains unclear to what extent and how densely the parameter space has been tested or validated which results for a sensor system in a specific application area with respect to environmental influences and detection conditions.
Likewise, no assessment is currently performed as to whether, or how well, the measurement method matches the specifications and requirements of the sensor/sensor system. For example, a sensor that operates in a specific spectral range should also be validated in that range.
A further absence of clarity in the current approach is that the robustness of a sensor/sensor system against expected interference influences that can have an impact on the real application in a specific application case is not tested on a targeted basis. For this purpose, both the specific application and the sensor-specific influence domains must be taken into account.
In order to validate new sensors with partly new properties but also specific feedback mechanisms, test points that are inadequate for validation are if applicable used if these were defined in a non-specific manner (e.g. in a standard).

In the context of sensor simulation for hardware development and development of perception algorithms, validated sensor models and simulation environments are required.
Until now, comparisons between actual sensor behavior and the simulation have been performed on the basis of only a few test points. If the similarity is high, sensor models are said to be validated. However, a recognized and comprehensible quality measure has not yet been defined. It remains unclear how good or reliable the validation is for a specific sensor model in a simulation environment.
It remains unclear how high the number of test points is, how densely the parameter space is covered and whether this is adequate for certain simulation purposes.
Particularly for the simulation of corner cases, it remains unclear whether the simulation can represent these for specific sensor properties and whether the simulation environment can represent the necessary parameters in order to be able to reliably detect limit crossings.

The method (or embodiments thereof) of the present invention disclosed in this disclosure builds on established procedures and thereby makes the assessment, qualification and/or extension of sensor validation possible.
The application case and the resulting specific requirements and specific sensor properties are detected and taken into account.
Based on a priori domain knowledge and validations already performed, specific test domains for assessment are systematically defined. According to the application case and properties of the sensor, parameter spaces for functional domains, i.e. the anticipated operating space, and limit test domains, i.e. interference influences and corner cases, are defined.
With the aid of the test domains, coverage measures are determined for validation with test points. These coverage measures serve to qualify the sensor validation. The requirements for the coverage can depend on the application case (e.g. safety-critical or only a comfort function).
Gaps in the test of the sensor with respect to the operating range and interference influences can be iteratively detected and ultimately also closed. Manufacturers and users of sensor models (i.e. virtual imaging sensors) can thus recognize in which simulation environment, for which application area and up to which limits a sensor model can be used and what quality it achieves within these limits.
Quality metrics are defined for how extensively sensor models have been validated in a simulation environment and according to which test domains.
This makes possible a qualification of the degree of coverage and the coverage limits of sensor models for specific applications.
Sensor models can also be assessed for partial aspects with respect to their applicability, with the aid of the coverage of the corresponding test domains (e.g. only validated for daytime scenes, etc.)
For assessing applicability for the simulation of corner cases, tests are systematically developed that also provide targeted limit-exceeding excitations in order to check the system limits (limit test domains).

### BRIEF DESCRIPTION OF THE DRAWINGS

FIG. 1 schematically illustrates two exemplary parameter ranges, namely intensity and a measure of how rapidly the intensity is changing.

FIGS. 2A and 2B schematically illustrate exemplary embodiments of a method for assessing an imaging sensor, a virtual imaging sensor and/or a specification of the imaging sensor, according to the present invention.

### DETAILED DESCRIPTION OF EXAMPLE EMBODIMENTS

The method 100 of the present invention disclosure herein is aimed at the assessment of an imaging sensor, an associated virtual imaging sensor and/or a specification of the imaging sensor. For example, the method can be aimed at the assessment of the imaging sensor. Alternatively or additionally, the method can be aimed at the assessment of the associated virtual imaging sensor. Alternatively or additionally, the method can be based on the assessment of a specification of the imaging sensor.

The virtual imaging sensor can be a virtual imaging sensor assigned to the imaging sensor, in particular a digital twin of the imaging sensor. Therefore, the specification can also be a specification of the virtual imaging sensor.

The assessment serves to validate and ultimately release the imaging sensor, the virtual imaging sensor and/or the specification.

The imaging sensor can be a sensor, in particular an optical sensor. The imaging sensor can also be a sensor system consisting of several sensors. In particular, the imaging sensor can be a camera.

The imaging sensor can be a sensor or sensor system of a technical system such as a vehicle or a robot. The validation and release of imaging sensors and/or associated virtual imaging sensors are particularly relevant for safety-relevant applications such as autonomous driving/mobility (e.g. SAE Level 4 or higher), robotics, SafeAI, etc.

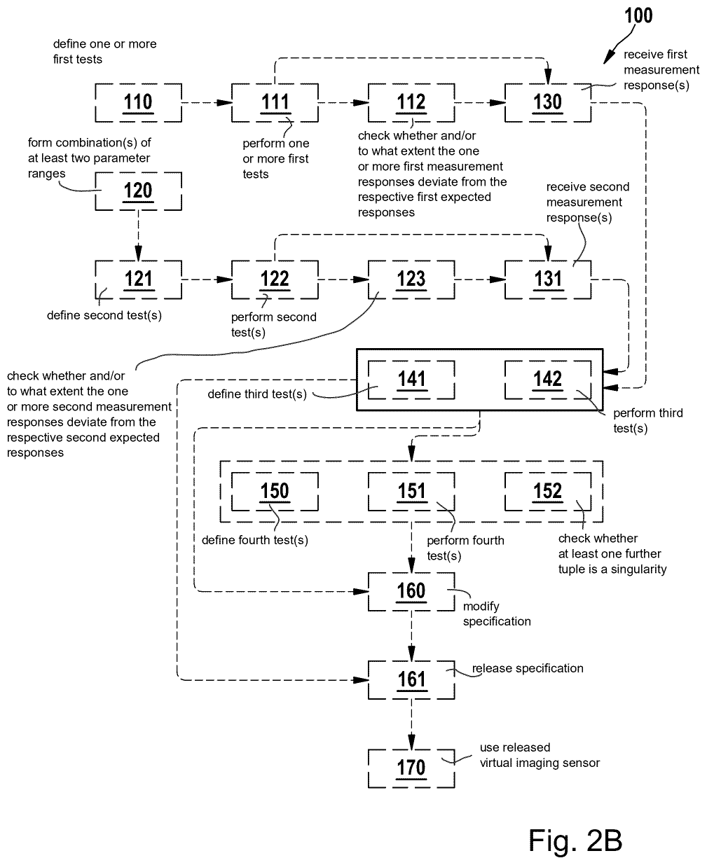

A method 100 is disclosed, such as schematically illustrated in FIGS. 2A and 2B, for the assessment (in particular for the release) of an imaging sensor, a virtual imaging sensor and/or a specification of the imaging sensor.

The specification comprises at least two parameter ranges 1, 2, wherein a particular parameter range is an operating range in which the imaging sensor (and/or the virtual imaging sensor) is to function, or an interference range with which the imaging sensor (and/or the virtual imaging sensor) is intended to cope. The specification can comprise a plurality of parameter ranges, in particular a plurality of operating ranges and/or a plurality of interference ranges. A (particular) parameter range can be e.g. a set or an interval of parameter values. A (particular) parameter range can be continuous or discrete. The method 100 can comprise receiving the specification.

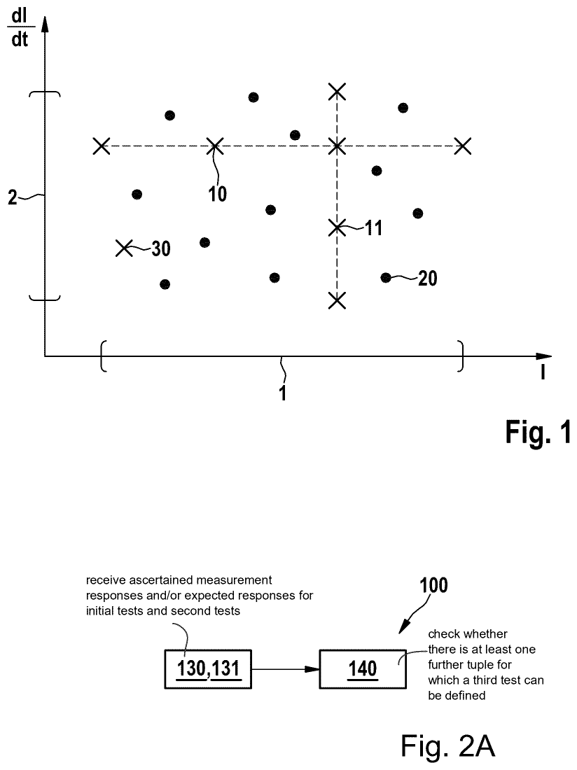

FIG. 1 schematically illustrates two exemplary parameter ranges 1, 2, namely one 1 for an intensity/and another 2 for a measure (indicated by dl/dt) of how rapidly the intensity is changing. Each point 10, 11, 20, 30 can be a combination of parameter values from these two parameter ranges 1, 2 (and, if applicable, from one or more other parameter ranges).

The parameter ranges can comprise at least one operating range of a spatial resolution. Alternatively or additionally, the parameter ranges can comprise at least one operating range of a spectral resolution. Alternatively or additionally, the parameter ranges can comprise at least one operating range of a temporal resolution. Alternatively or additionally, the parameter ranges can comprise at least one operating range with different polarizations. Alternatively or additionally, the parameter ranges can comprise at least one operating range with different intensities (see parameter range 1 in FIG. 1). Alternatively or additionally, the parameter ranges can comprise at least one operating range with different relative velocities between the sensor and an object detected by the sensor. Alternatively or additionally, the parameter ranges can comprise at least one operating range with different feedback settings of the sensor.

Alternatively or additionally, the parameter ranges can comprise at least one interference range of a variability of a signal source, e.g. an interference range with varying properties of the signal source. Alternatively or additionally, the parameter ranges can comprise at least one interference range with different temperatures, in particular due to ambient or self-heating. Alternatively or additionally, the parameter ranges can comprise at least one interference range with different mechanical relative movements of optical elements in the sensor. Alternatively or additionally, the parameter ranges can comprise at least one interference range with vibrations, in particular due to self-movement. Alternatively or additionally, the parameter ranges can comprise at least one interference range with interference radiation, in particular reflections. Alternatively or additionally, the parameter ranges can comprise at least one interference range with aging effects.

The parameter ranges can thus comprise one or more operating ranges and/or one or more interference ranges.

The method 100 can comprise, as schematically illustrated, e.g. in FIGS. 2A and 2B, receiving 130, for each of one or more first tests 10, 11 based in each case on one of the at least two parameter ranges 1, 2, a first measurement response ascertained in response to a first stimulus and/or a first response expected for the first stimulus; and/or (receiving) 131, for each of one or more second tests 20 based in each case on a combination of the at least two parameter ranges 1, 2, wherein one or more tuples of parameter values are formed from at least the at least two parameter ranges 1, 2, a second measurement response ascertained in response to a second stimulus and/or a second response expected for the second stimulus. The method 100 can thus comprise receiving 130 ascertained measurement responses and/or expected responses for initial tests. Alternatively or additionally, the method 100 can also comprise receiving 131 ascertained measurement responses and/or expected responses for second tests. In particular, the method can comprise receiving 130 ascertained measurement responses and/or expected responses for first tests and receiving 131 ascertained measurement responses and/or expected responses for second tests.

As schematically illustrated in FIG. 1, initial tests can be defined by individual points of a parameter range, wherein further coordinations of other parameter ranges can be kept constant.

A first test 10 is based e.g. on one 1 of at least two parameter ranges. In this case, the first test 10 is obtained from parameter values from this one 1 parameter range being varied, wherein further parameter values from other parameter ranges are kept constant. A first test 11 is based e.g. on the other 2 of the at least two parameter ranges. In this case, the first test 11 is obtained from parameter values from this other 2 parameter range being varied, wherein further parameter values from other parameter ranges are kept constant.

The first tests 10, 11 can comprise one or more tests 10 based on one 1 of the at least two parameter ranges 1, 2 and one or more tests 11 based on the other 2 of the at least two parameter ranges 1, 2. If a first test is based on one of at least two parameter ranges, a particular first stimulus can be based on (different) parameter values from this parameter range. On the other hand, if a first test is based on the other of the at least two parameter ranges, a particular first stimulus can be based on (different) parameter values from this parameter range.

As schematically illustrated in FIG. 1, second tests can be defined by combining individual points of parameter ranges.

In method 100, at least two tests, i.e. at least two first tests, at least two second tests or at least one first and second test, are received.

The method 100 can comprise, as schematically illustrated in FIG. 2B, defining 110, for each parameter range, one or more first tests based on the particular parameter range, wherein in each case the first stimulus and the first response expected for the first stimulus are obtained.

The method 100 can further comprise, as schematically illustrated in FIG. 2B, performing 111 the one or more first tests in a real test bench comprising the imaging sensor and/or in a virtual test bench comprising the virtual imaging sensor, wherein the particular first measurement response is obtained (e.g. is recorded) for each first stimulus. For example, the one or more first tests can only be performed on the real test bench 111. Alternatively, for example, the one or more first tests can be performed only on the virtual test bench 111. In this case, the particular expected response can, but does not have to, be a measurement response from the real test bench.

The method 100 can further comprise, as schematically illustrated in FIG. 2B, checking 112 whether and/or to what extent the one or more first measurement responses deviate from the respective first expected responses, wherein a first test result is obtained. Checking 112 can be based on a first predetermined deviation criterion. As schematically illustrated in FIG. 2B, step 112 can also be skipped.

The method 100 can comprise, as schematically illustrated in FIG. 2B, forming 120 the one or more combinations of the at least two parameter ranges.

The method 100 can further comprise, as schematically illustrated in FIG. 2B, defining 121, for each tuple, one or more second tests based on the tuple, wherein in each case the second stimulus and the second response expected from the imaging sensor are obtained.

The method 100 can further comprise, as schematically illustrated in FIG. 2B, performing 122 the one or more second tests in a real test bench (e.g. the real test bench) comprising the imaging sensor and/or in a virtual test bench (e.g. the virtual test bench) comprising the virtual imaging sensor, wherein the particular second measurement response is obtained (e.g. is recorded) for each second test. For example, the one or more first tests can only be performed on the real test bench 122. Alternatively, for example, the one or more first tests can be performed only on the virtual test bench 122. In this case, the particular expected response can, but does not have to, be a measurement response from the real test bench.

The method 100 can further comprise, as schematically illustrated in FIG. 2B, checking 123 whether and/or to what extent the one or more second measurement responses deviate from the respective second expected responses, wherein a second test result is obtained. Checking 123 can be based on a second predetermined deviation criterion. As schematically illustrated in FIG. 2B, step 123 can also be skipped.

The method 100 further comprises, as schematically illustrated, e.g. in FIGS. 2A and 2B, checking 140 whether there is at least one further tuple of parameter values from the at least two parameter ranges 1, 2 (i.e. a further tuple according to the specification) for which a third test 30 can be defined, the third measurement response of which ascertained in response to a third stimulus and/or the third response of which expected for the third stimulus (preferred because it requires less effort) deviating sufficiently from an interpolation of first and/or second measurement responses and/or from an interpolation of first and/or second expected responses, wherein a third test result is obtained.

The method 100 can comprise, as schematically illustrated, e.g. in FIG. 2B, defining 141, for each further tuple, one or more third tests based on the further tuple, wherein in each case the third stimulus and the third response expected from the imaging sensor are obtained.

The method 100 can further comprise, as schematically illustrated, e.g. in FIG. 2B, performing 142 the one or more third tests in a real test bench (e.g. the real test bench) comprising the imaging sensor and/or in a virtual test bench (e.g. the virtual test bench) comprising the virtual imaging sensor, wherein the particular third measurement response is obtained (e.g. is recorded) for each third test.

The method 100 can comprise, as schematically illustrated in FIG. 2B, defining 150 one or more fourth tests based on an environment of the at least one further tuple of parameter values, wherein in each case a fourth stimulus and, optionally, a fourth response expected for the fourth stimulus are obtained.

The method 100 can further comprise, as schematically illustrated in FIG. 2B, performing 151 the one or more fourth tests in a real test bench comprising the imaging sensor and/or in a virtual test bench comprising the virtual imaging sensor, wherein the particular fourth measurement response is obtained (e.g. is recorded) for each fourth stimulus.

The method 100 can further comprise, as schematically illustrated in FIG. 2B, checking 152 based on at least one fourth measurement response and/or optionally at least one fourth expected response whether the at least one further tuple (e.g. with regard to the interpolation) is a singularity, wherein the third test result is revised (i.e. overwritten).

If a singularity is found, the singularity can e.g. be excluded from the specification. The specification can thus be modified here 160. If, however, no singularity is found, the tests can be extended by the fourth tests and the third test result can also be extended by further tuples from the fourth tests. This can be regarded as re-measuring in an environment around at least one other tuple.

As schematically illustrated in FIG. 2B, steps 150, 151 and/or 152 can also be skipped.

As schematically illustrated in FIG. 2B, the method 100 can comprise modifying 160 the specification, the imaging sensor and/or the virtual imaging sensor on the basis of the third test result, in particular if the third test result is positive (i.e. if there is at least one further tuple of parameter values that deviates sufficiently from the interpolation). For example, the imaging sensor and/or the virtual imaging sensor can be modified 160 such that when the method 100 is repeated on the basis of the existing first and/or second tests, there is no further tuple of parameter values that deviates sufficiently from the interpolation. Alternatively, the specification can be modified 160 so that the further tuple is no longer located in the specification. Such a specification change is possible if the specification was too strict. For example, it may be sufficient for a certain functionality only to be available during the day. As schematically illustrated in FIG. 2B, step 160 can also be skipped.

The method 100 can comprise, as schematically illustrated in FIG. 2B releasing 161 the specification, of the imaging sensor and/or the virtual imaging sensor, based on the third test result, in particular at least if the third test result is negative (i.e. if there is at least no further tuple of parameter values that deviates sufficiently from the interpolation), optionally if the first test result and/or the second test result are also negative (i.e. if first/second measurement responses do not deviate sufficiently from the first/second expected responses). In particular, in method 100, the imaging sensor can be enabled 161. Alternatively or additionally, in method 100, the virtual imaging sensor can be enabled 161. Alternatively or additionally, the specification of the imaging sensor (or the virtual imaging sensor) can be released 161 in the method 100.

For example, if there is no further tuple of parameter values that deviates sufficiently from the interpolation, sufficient coverage of the operating and/or interference ranges of the imaging sensor and/or the virtual imaging sensor can be achieved by the interpolation based on first and second tests.

The method 100 can comprise manufacturing one or more additional imaging sensors based on the modified 160 specification, on the modified 160 imaging sensor and/or on the modified 160 virtual imaging sensor.

As schematically illustrated in FIG. 2B, the method 100 can comprise using 170 the released 161 virtual imaging sensor for the design, development and/or maintenance of the imaging sensor. This is advantageous because the use of the virtual imaging sensor can accelerate testing. On the other hand, the method 100 can also comprise using the released imaging sensor for the design, development and/or maintenance of the imaging sensor.

The method 100 can comprise manufacturing and/or modifying the imaging sensor on the basis of the released 161 virtual imaging sensor. In particular, the method 100 can comprise manufacturing and/or modifying the imaging sensor on the basis of the virtual imaging sensor used 170 and released 161 for the design, development and/or maintenance of the imaging sensor.

In method 100, a plurality of tests (first, second, third and/or fourth tests) of the imaging sensor and/or of the virtual imaging sensor can be performed, wherein a plurality of test results (e.g. in each case with one test result per test or with one test result per test and imaging sensor or virtual imaging sensor) are obtained. For example, at least one test result can be based on a comparison with a test target. The variety of tests is based on an application case of the imaging sensor, in particular on the specification. The specification can comprise one or more requirements for the imaging sensor.

Performing the plurality of tests of the imaging sensor can comprise a test point for each test (e.g. on a “MacBeth chart,” resolution targets, further test targets in the measuring stand, etc.) and an associated evaluation. At least one test point or all test points can initially be defined from prior knowledge. In particular, one test point or all test points can comprise such test points that are established in imaging sensor technology. Likewise, the evaluations can comprise evaluations that are established in imaging sensor technology.

For example, the imaging sensor, or more generally a sensor system that comprises, for example, the imaging sensor, means for illumination, image processing and feedback, can be measured with respect to certain states.

For example, one or more imaging sensors can be measured using test targets. One or more test targets can be calibration targets. For this purpose, defined measurement points can be recorded using the imaging sensor or sensor system under defined conditions. These measurement points can comprise, e.g. color or reflectance targets with defined surface properties and/or backscattering, which are recorded under the influence of a defined illumination or an active, calibrated excitation source. The output (e.g. color image, video stream, etc.) of the imaging sensor or the sensor system can be compared with reference points belonging to the measurement points according to a predetermined calculation method. With the aid of the deviation of the reference points from the values detected by means of the sensor, the quality of the sensor with respect to the test points and operating conditions can be assessed, thus a calibration can be performed based on the reference points or a comparison with the sensor's specifications can be carried out.

Performing the plurality of tests of the virtual imaging sensor can be carried out in simulation. This can be carried out in a manner as similar as possible or in the same way as performing the multitude of tests on the imaging sensor.

For example, for quantifying the test and validation quality of the imaging sensor and/or the virtual imaging sensor, the operating range and the interference range of the imaging sensor can be derived from the specification and/or requirements (derived from the application area) for specific quality domains in the form of functional and limit test domains.

The operating range can, for example, comprise an expected range of intensities occurring in the application case (e.g. restriction to lighting situations that can occur in a limited geographical area if, e.g. the system is to be deployed and secured only there). Alternatively or additionally, the operating range can comprise expected relative velocities between the sensor and an object detected by the sensor (e.g. restriction of the ego and external velocities to a range supported by legal requirements and an expected exceedance range in an application, e.g. in parking garages).

The interference range can, for example, comprise (interference) radiation outside the intensities defined in the operating range, which can comprise, e.g. terrestrial events such as local influences caused by lightning or solar reflections. Alternatively or additionally, the interference range can comprise vibrations, e.g. due to the transmission of road surface irregularities superimposed on the expected relative movement.

The operating range and/or the interference range can serve as an envelope for analysis and for deriving coverage measures. The measurement points of tests performed can be transferred to these ranges.

By deriving sensor- and application-specific ranges for relevant functional and limit test domains and subsequently comparing the detected measurement points with these ranges, the extent to which the desired behavior of the imaging sensor is covered by the plurality of tests can be assessed. In particular, gaps in coverage for different quality domains can be recognized. This coverage and gaps serve to qualify the validation of the imaging sensor and/or the virtual imaging sensor and consequently their applicability according to the intended use (e.g. comfort function or safety-critical). Greater coverage is typically required for safety-critical functions. The analysis of the gaps also serves to iteratively expand the definition of functional and/or limit test domains as well as to develop new tests in order to increase the coverage in the required regions of the imaging sensor. This can also increase the qualification.

In contrast to the established approach based on a few established test points, the plurality of tests is defined on the basis of an application case. The plurality of tests can on the basis of the application case be expanded in order to scan and ultimately close gaps in the relevant parameter space. The expansion of the plurality of tests and hence the plurality of tests can be based on the specification, i.e. on requirements for the imaging sensor. In particular, the expansion of the plurality of tests and the plurality of tests can be based on the operating range (also: functional domain) and/or the interference range (also: limit test domain) of the imaging sensor. Alternatively or additionally, the expansion of the plurality of tests and the plurality of tests can be based on expert and/or prior knowledge.

The test of the imaging sensor is thus based on one application case or even on a plurality of application cases. The application cases determine the specification, requirements and/or application area of the imaging sensor. According to, e.g. the requirements and/or the specification, suitable tests can be defined and performed. In addition, existing domain knowledge with respect to the functional areas and/or limits of the sensor technology can be applied in the form of functional (operating range) and limit test domains (interference range) defined with parameter ranges and/or limits in order to generate further tests. The aim of these additional tests is to achieve a high test coverage of the sensor properties and sensor performance in the intended or possible application environment. The functional domains can describe sensor and environmental states that correspond to the expected use of the sensor system. The limit test domains can describe possible interference influences and corner cases of the sensor system and the environment.

The parameter ranges of the functional and limit test domains serve to determine coverage. Conclusions with respect to coverage and gaps in sensor validation can be used to iteratively improve and expand domain definitions and/or generate improved tests. The iterative process can lead to a suspected uncertainty being initially investigated with denser parameter steps, which can later be thinned out again once it has been ensured that intermediate states of a parameter space do not have a negative impact on the recognition performance of an imaging sensor in the application. This allows the effort (e.g. power consumption, velocity) for performing or simulating the test to be optimized with a high degree of coverage.

Also disclosed is a computer system that is configured to execute the computer-implemented method 100 for assessing an imaging sensor, an associated virtual imaging sensor and/or a specification of the imaging sensor. The computer system can comprise a processor and/or a working memory.

Also disclosed is a computer program that is configured to execute the computer-implemented method 100 for assessing an imaging sensor, an associated virtual imaging sensor and/or a specification of the imaging sensor. The computer program can be present, for example, in interpretable or in compiled form. For execution, it can (even in portions) be loaded into the RAM of a computer, e.g. as a bit or byte sequence.

Also disclosed is a signal that is configured to comprise, in particular to encode, the computer-implemented method 100 for assessing an imaging sensor, an associated virtual imaging sensor and/or a specification of the imaging sensor.

Also disclosed is a computer-readable medium that stores and/or contains the computer program. The medium can comprise, for example, any one of RAM, ROM, EPROM, HDD, SSD, . . . , on/in which the signal is stored.

1-15 (canceled)

16. A computer-implemented method for assessing an imaging sensor and/or an associated virtual imaging sensor and/or a specification of the imaging sensor, wherein the specification includes at least two parameter ranges, wherein a particular parameter range is an operating range in which the imaging sensor is to function or an interference range with which the imaging sensor is intended to cope, the method comprising the following steps:;
receiving:
for each of one or more first tests based in each case on one of the at least two parameter ranges, a first measurement response ascertained in response to a first stimulus and/or a first response expected for the first stimulus, and/or
for each of one or more second tests based in each case on a combination of the at least two parameter ranges, wherein one or more tuples of parameter values are formed from at least the at least two parameter ranges, a second measurement response ascertained in response to a second stimulus and/or a second response expected for the second stimulus;
checking whether there is at least one further tuple of parameter values from the at least two parameter ranges for which a third test can be defined, a third measurement response of which ascertained in response to a third stimulus and/or the third response of which expected for the third stimulus deviating sufficiently: (i) from an interpolation of the first and/or second measurement responses and/or (ii) from an interpolation of the first and/or second expected responses, wherein a third test result is obtained.

17. The method according to claim 16, further comprising:
defining one or more fourth tests based on an environment of the at least one further tuple of parameter values, wherein in each case a fourth stimulus is obtained.

18. The method according to claim 17, further comprising:
performing the one or more fourth tests: (i) in a real test bench including the imaging sensor and/or (ii) in a virtual test bench including the virtual imaging sensor, wherein a respective fourth measurement response is obtained for each fourth stimulus.

19. The method according to claim 17, further comprising:
checking based on at least one fourth measurement response and/or at least one fourth expected response whether the at least one further tuple is a singularity, wherein the third test result is revised.

20. The method according to claim 16, further comprising:
modifying the specification and/or the imaging sensor and/or the virtual imaging sensor based on the third test result, when the third test result is positive.

21. The method according to claim 16, further comprising:
defining, for each parameter range, one or more first tests based on the particular parameter range, wherein in each case the first stimulus and the first response expected for the first stimulus are obtained.

22. The method according to claim 16, further comprising:
performing the one or more first tests: (i) in a real test bench including the imaging sensor and/or (ii) in a virtual test bench including the virtual imaging sensor, wherein the particular first measurement response is obtained for each first stimulus.

23. The method according to claim 16, further comprising:
checking whether and/or to what extent the one or more first measurement responses deviate from the first expected responses, wherein a first test result is obtained.

24. The method according to claim 16, further comprising the following steps:
forming the one or more combinations of the at least two parameter ranges;
defining, for each tuple, one or more second tests based on the tuple, wherein in each case the second stimulus and the second response expected from the imaging sensor are obtained.

25. The method according to claim 16, further comprising:
performing the one or more second tests: (i) in a real test bench including the imaging sensor and/or (ii) in a virtual test bench including the virtual imaging sensor, wherein a respective second measurement response is obtained for each second stimulus.

26. The method according to claim 16, further comprising:
checking whether and/or to what extent the one or more second measurement responses deviate from the second expected responses, wherein a second test result is obtained.

27. The method according to claim 16, further comprising:
releasing the specification and/or the imaging sensor and/or the virtual imaging sensor based on the third test result, when the third test result is negative.

28. The method according to claim 27, further comprising:
using the released virtual imaging sensor for design and/or development and/or maintenance of the imaging sensor.

29. The method according to claim 28, further comprising:
manufacturing and/or modifying the imaging sensor based on the released virtual imaging sensor.

30. A computer system that is configured to execute a computer-implemented method for assessing an imaging sensor and/or an associated virtual imaging sensor and/or a specification of the imaging sensor, wherein the specification includes at least two parameter ranges, wherein a particular parameter range is an operating range in which the imaging sensor is to function or an interference range with which the imaging sensor is intended to cope, wherein the computer-implemented method comprises the following steps:;
receiving:
for each of one or more first tests based in each case on one of the at least two parameter ranges, a first measurement response ascertained in response to a first stimulus and/or a first response expected for the first stimulus, and/or
for each of one or more second tests based in each case on a combination of the at least two parameter ranges, wherein one or more tuples of parameter values are formed from at least the at least two parameter ranges, a second measurement response ascertained in response to a second stimulus and/or a second response expected for the second stimulus;
checking whether there is at least one further tuple of parameter values from the at least two parameter ranges for which a third test can be defined, a third measurement response of which ascertained in response to a third stimulus and/or the third response of which expected for the third stimulus deviating sufficiently: (i) from an interpolation of the first and/or second measurement responses and/or (ii) from an interpolation of the first and/or second expected responses, wherein a third test result is obtained.

31. A non-transitory computer-readable medium on which is stored a computer program for assessing an imaging sensor and/or an associated virtual imaging sensor and/or a specification of the imaging sensor, wherein the specification includes at least two parameter ranges, wherein a particular parameter range is an operating range in which the imaging sensor is to function or an interference range with which the imaging sensor is intended to cope, the computer program, when executed by a computer, causing the computer to perform the following steps:;
receiving:
for each of one or more first tests based in each case on one of the at least two parameter ranges, a first measurement response ascertained in response to a first stimulus and/or a first response expected for the first stimulus, and/or
for each of one or more second tests based in each case on a combination of the at least two parameter ranges, wherein one or more tuples of parameter values are formed from at least the at least two parameter ranges, a second measurement response ascertained in response to a second stimulus and/or a second response expected for the second stimulus;
checking whether there is at least one further tuple of parameter values from the at least two parameter ranges for which a third test can be defined, a third measurement response of which ascertained in response to a third stimulus and/or the third response of which expected for the third stimulus deviating sufficiently: (i) from an interpolation of the first and/or second measurement responses and/or (ii) from an interpolation of the first and/or second expected responses, wherein a third test result is obtained.
